(19) United States
(12) Patent Application Publication
(10) Pub. No.: US 2010/0051128 A1
(43) Pub. Date: Mar. 4, 2010

(54) FLUID TRANSPORT CHANNEL, FLUID PROCESSING APPARATUS AND FLUID PROCESSING SYSTEM

(75) Inventor: Takahiro Ezaki, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/528,972

(22) PCT Filed: Feb. 18, 2008
(86) PCT No.: PCT/JP2008/053117

§ 371 Date: Aug. 27, 2009

(30) Foreign Application Priority Data
Mar. 2, 2007 (JP) 2007-053255

(51) Int. Cl. F15D 1/00

(52) U.S. Cl. 137/597; 137/561 R

(57) ABSTRACT

A fluid transport channel is provide including a flow inlet from which fluid flows in, a flow channel through which the fluid is transported, a branched portion provided in the flow channel to change the movement direction of the fluid, and flow outlets from which the fluid having passed through the branched portions flows out. A region where the movement direction of the fluid is changed is present between the flow inlet and the branched portion. In that region, the center line extending in the movement direction of the fluid in the flow channel extends along a range of two arcs having different centers, and the range is composed of such two arcs as to make the directions of the fluid turning along the arcs opposite to each other. Each of the arcs has a specific angle relative to an angle at which the movement direction of the fluid changes.

### TECHNICAL FIELD

This invention relates to a fluid transport channel, and a fluid processing apparatus and a fluid processing system which are used for causing fluids to mix or react with each other, and more particularly to what is suitable for a fluid transport channel which transports a fluid at a high velocity and for the fluid processing apparatus.

### BACKGROUND ART

In recent years, in the field of chemical industries concerned with the production of pigments and so forth used in inks for ink-jet printers and the field of pharmaceutical industries concerned with the production of pharmaceuticals, reagents and so forth, a new production process is being developed which makes use of a minute container called a micro-mixer or a micro-reactor.

In conventional batch type reactors, there is a possibility of causing non-uniformity of products because primary products may continually react inside a reactor. Especially where fine particles are produced, there is a possibility that primary particles of fine particles having been formed once further grow as a result of reaction to cause non-uniformity in size of the fine particles.

On the other hand, in the micro-mixer, fluids pass continuously through a micro-scale flow channel with almost no stagnation, and hence the fine particles having been formed once can be prevented from reacting again, so that the uniformity in size of the fine particles can be improved.

The micro-mixer and the micro-reactor are set to be common to each other in their basic structure. In particular, one which involves chemical reaction when two or more types of solutions are mixed is called the micro-reactor in some cases. Accordingly, in the following description, the micro-mixer is deemed to include the micro-reactor.

As for such a micro-mixer, a means is disclosed in which, as shown in FIG. 21, two kinds of liquids are mixed at a high speed to form solid deposits (Japanese Patent Application Laid-Open No. 2002-336667). This is a means in which two types of liquids are fed to orifices 2101 and 2102 and subsequently pass through shielded portions 2103 broaden toward the end at a high velocity, whereby the solid deposits are produced in a jet impact mixing chamber 2104. As also shown in FIG. 22, a micro-mixer made of metal in which oblique nozzles have been formed by mechanical working is commercially available (Impinging Jet Micro-mixer, manufactured by Institute fur Mikrotechnik Mainz). This is a micro-mixer in which liquids are jetted out of nozzles 2201 and 2202 and the liquids jetted out are mixed in the air.

The use of any of the micro-mixers having such features enables formation of particles which are finer and have narrower particle size distribution than those produced by any conventional batch process making use of a large-volume tank or the like as a space for mixing and reaction.

In order to improve productivity in regard to such techniques, it is necessary to prepare the nozzles in a large number. It is also necessary to provide a flow channel for feeding the liquid evenly to the large number of nozzles. As for such a flow channel, a mean is disclosed in which, as shown in FIG. 23, the flow channel lengths of a flow channel from its inlet to outlets are set to be equal (Japanese Patent Application Laid-open No. H07-090572). In this means, the flow channel has equal flow resistance from its inlet 2301 to outlets 2302, and hence the flow-out pressure of a fluid can be made uniform for each flow outlet.

In the feeding flow channel as in the foregoing, the flow velocity of the fluid flowing through the feeding flow channel increases with an increase in the flow rate of the fluid to be fed. When being allowed to flow at a high flow velocity, the fluid having passed through curved portions of the flow channel become ill-balanced in velocity distribution depending on changes in its movement direction.

The fluid ill-balanced in velocity distribution comes into branched portions provided downstream, where the difference between the quantities of the divided fluids occurs. The flow rates at flow outlets become more ill-balanced as branching is repeated many times. As a result, it becomes difficult to keep the uniformity of mixing or reaction. There has been such a problem.

In addition, in a fluid processing apparatus in which two types of fluids jetted out of nozzles are caused to collide with each other to allow them to mix or react, an attempt to provide a larger number of nozzles so as to improve productivity results in an increase in the flow rate of the fluid to be fed. In this case, the differences between jet-out flow rates at respective nozzles increase to prevent reaction from being uniformized in some cases.

### DISCLOSURE OF THE INVENTION

The first embodiment of the fluid transport channel the present invention provides, is a fluid transport channel including a flow inlet from which fluid flows in, a flow channel through which the fluid is transported, a branched portion which is provided in the flow channel, and changes and branches the direction of movement of the fluid, and a plurality of flow outlets from which the fluid having passed through the branched portions flows out, wherein

a region in which the direction of movement of the fluid is changed is present between the flow inlet and the branched portion;

in the region, the center line extending in the direction of movement of the fluid in the flow channel extends along a range of first and second circular arcs whose centers are located at positions different from each other, and the range of first and second circular arcs is composed of a combination of such two circular arcs as to make the directions of the fluid turning along the circular arcs opposite to each other; and

where an angle at which the direction of movement of the fluid changes is defined as θ, the first circular arc has an angle of A×θ and the second circular arc has an angle of (A−1)×θ where A represents a positive integer or decimal.

The second embodiment of the fluid transport channel the present invention provides, is a fluid transport channel in a single series extending from one flow inlet from which fluid flows in, to flow outlets of branched channels which are formed so that a channel is firstly branched at a branched portion where the direction of movement of the fluid is changed and branched, to form two first branched channels, and each of the two second branched channels is secondly branched to form second branched channels, which are further successively branched to form branched channels, wherein

regions where the direction of movement of the fluid is changed are present in the branched channels;

in the regions, the center line extending in the direction of movement of the fluid in each branched channel extends along a range of first and second circular arcs whose centers are located at positions different from each other, and the range of first and second circular arcs is composed of a combination of such two circular arcs as to make the directions of the fluid turning along the circular arcs opposite to each other; and

where an angle at which the direction of movement of the fluid changes is defined as θ, the first circular arc has an angle of A×θ and the second circular arc has an angle of (A−1)×θ where A represents a positive integer or decimal.

The fluid transport channel of the present invention also embraces a fluid transport channel having two regions where the direction of movement of the fluid is changed, between the flow inlet and the branched portion or between the branched portion and the branched portion.

The fluid processing apparatus of the present invention is a fluid processing apparatus which includes a first-fluid dividing flow channel and a second-fluid dividing flow channel provided correspondingly to the first-fluid dividing flow channel, and causes a first fluid flowing out of the first-fluid dividing flow channel from its flow outlets and a second fluid flowing out of the second-fluid dividing flow channel from its flow outlets to collide with each other to allow the fluids to mix or react, wherein the first-fluid dividing flow channel and the second-fluid dividing flow channel are each provided with the fluid transport channel described above.

The fluid processing system of the present invention is characterized by including the fluid processing apparatus described above, transport means for transporting the first and second fluids, fluid control means for controlling the transport means, a feed fluid storing apparatus which stores the first and second fluids to be fed to the fluid processing apparatus, a flow-out fluid storing apparatus which stores a treated fluid flowing out of the fluid processing apparatus.

According to the present invention, in the fluid transport channel through which the fluid is transported at a high velocity and divided into a plurality of flow outlets, the velocity distribution of the fluid is kept symmetrical with respect to the center line of the flow channel, thereby reducing the differences between the flow rates of the divided fluids.

According to the present invention, in the fluid processing apparatus in which fluids having jetted out of a large number of nozzles are caused to collide with each other to allow the fluids to mix or react, the differences between the jet-out flow rates at the nozzles can be reduced. Thus, a fluid processing apparatus can be provided which has been improved in uniformity of mixing or reaction.

The present invention can also provide a fluid processing system using the above fluid processing apparatus improved in the uniformity of mixing or reaction.

Further features of the present invention will become apparent from the following description of exemplary embodiments with reference to the attached drawings.

### BRIEF DESCRIPTION OF THE DRAWINGS

FIG. 1 is a perspective view showing a fluid processing apparatus of Example 1 in the present invention.

FIGS. 2A, 2B, 2C, 2D and 2E are explanatory diagrams for illustrating the fluid processing apparatus of Example 1 in the present invention.

FIGS. 3A, 3B, 3C, 3D and 3E are explanatory diagrams for illustrating a fluid processing apparatus in Example 2 of the present invention.

FIG. 4 is an explanatory diagram for illustrating a fluid dividing flow channel in Example 2 of the present invention.

FIG. 5 is an explanatory diagram for illustrating a fluid processing apparatus in Example 3 of the present invention.

FIG. 6 is an explanatory diagram for illustrating a fluid dividing flow channel in Example 3 of the present invention.

FIGS. 7A, 7B, 7C, 7D and 7E are explanatory diagrams for illustrating a fluid processing apparatus in Example 4 of the present invention.

FIG. 8 is an explanatory diagram for illustrating fluid dividing flow channels in Example 4 of the present invention.

FIG. 9 is an explanatory diagram for illustrating a fluid dividing flow channel in Example 4 of the present invention.

FIGS. 10A, 10B, 10C, 10D and 10E are explanatory diagrams for illustrating a fluid processing apparatus in Example 5 of the present invention.

FIG. 11 is an explanatory diagram for illustrating a fluid processing system in Example 6 of the present invention.

FIG. 12 is an explanatory diagram for illustrating an embodiment of the fluid transport channel of the present invention.

FIG. 13 is an explanatory diagram for illustrating an embodiment of the fluid transport channel of the present invention.

FIG. 14 is an explanatory diagram for illustrating an embodiment of the fluid transport channel of the present invention.

FIG. 15 is an explanatory diagram for illustrating a conventional fluid transport channel.

FIGS. 16A and 16B are respectively an explanatory diagram and a graph for demonstrating a conventional fluid transport channel.

FIGS. 17A and 17B are respectively an explanatory diagram and a graph for demonstrating the effect brought about by the fluid transport channel of the present invention.

FIGS. 18A and 18B are explanatory diagrams for illustrating embodiments of the fluid transport channel of the present invention.

FIG. 19 is an explanatory diagram for illustrating an embodiment of the fluid transport channel of the present invention.

FIG. 20 is an explanatory diagram for illustrating an embodiment of the fluid transport channel of the present invention.

FIG. 21 is an explanatory diagram for illustrating a conventional fluid processing apparatus.

FIG. 22 is an explanatory diagram for illustrating a conventional fluid processing apparatus.

FIG. 23 is an explanatory diagram for illustrating a conventional fluid transport channel.

FIGS. 24A, 24B, 24C, 24D and 24E are explanatory diagrams for illustrating a fluid processing apparatus of Example 7 in the present invention.

FIG. 25A is an explanatory diagram for illustrating the steps of producing a fluid processing apparatus in Example 7 of the present invention.

FIG. 25B is an explanatory diagram for illustrating the steps of producing the fluid processing apparatus in Example 7 of the present invention.

FIG. 26 is an explanatory diagram for illustrating fluid dividing flow channels formed in a fluid dividing flow channel substrate in Example 7 of the present invention.

### BEST MODES FOR PRACTICING THE INVENTION

In the following, the summary of the present invention is described and thereafter the fluid transport channel of the present invention is described in detail.

The fluid transport channel of the present invention is a fluid transport channel having a flow inlet from which fluid flows in, a flow channel through which the fluid is transported, a branched portion which is provided in the flow channel, and changes branches the direction of movement of the fluid, and a plurality of flow outlets from which the fluid having passed through the branched portions flows out, wherein

a region where the direction of movement of the fluid is changed is present between the flow inlet and the branched portion;

in the region, the center line extending in the direction of movement of the fluid in the flow channel extends along a range of two circular arcs whose centers are located at positions different from each other, and the range of two circular arcs is composed of such two circular arcs as to make the directions of the fluid turning along the circular arcs opposite to each other; and

where an angle at which the direction of movement of the fluid changes is defined as θ, the first circular arc has an angle of A×θ, where A represents a positive integer or decimal, and the second circular arc has an angle of (A−1)×θ.

The above A is preferably in the range of from 1.8 or more and 2.2 or less.

Where the radius of the first circular arc and the radius of the second circular arc are defined as R1 and R2, respectively, the R1 and R2 are preferably in the ratio R1/R2 of from 0.5 or more and 1.5 or less.

It is preferable that the two circular arcs are combined continuously.

Between the first circular arc and the second circular arc, the flow channel may have a straight-line portion having a length of 1/10 or less of the diameter of the flow channel that forms the circular arcs.

As to the fluid transport channel of the present invention, the shape of the circular arc is not limited to part of a circle, and may be composed of a combination of parts of circles, ellipses and/or sides.

The fluid transport channel will be described below in detail.

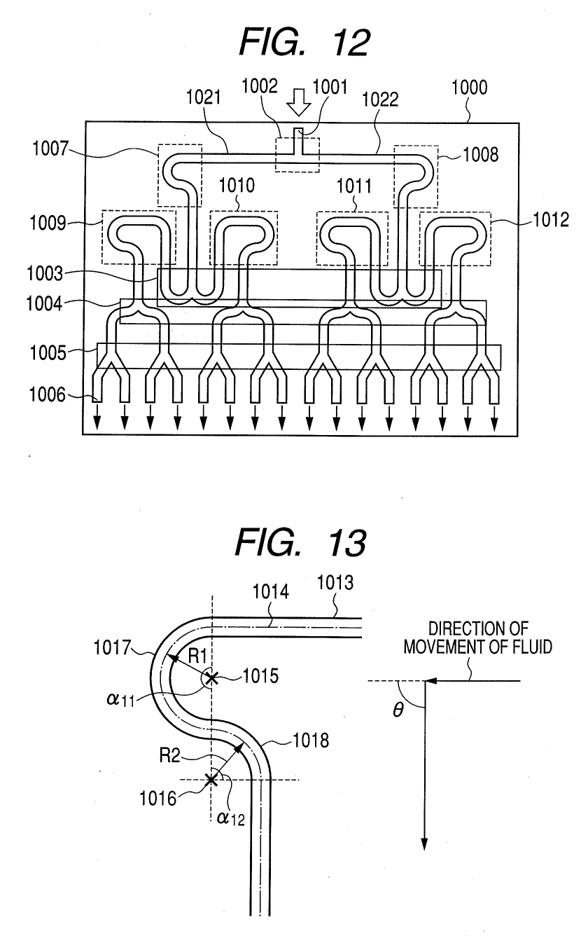

FIG. 12 is a schematic view for illustrating a fluid transport channel 1000 of the fluid transport channel of the present invention.

As shown in FIG. 12, a flow inlet 1001 and a branched portion 1002 are connected. At the branched portion 1002, the flow channel branches off into two ways. The branched portion 1002 is, at its exits, connected to two branched channels 1021 and 1022, and the branched channels 1021 and 1022 are connected to entrances of branched portions 1003.

The branched portions 1003 each branch off into two ways, and exits of the branched portions 1003 are connected to entrances of branched portions 1004. Exits of the branched portions 1004 are further connected to entrances of branched portions 1005. Then, exits of the branched portions 1005 are connected to flow outlets 1006. That is, as the flow channel extends downstream, it braches off successively at the branched portions, and the number of the branched channels increases.

A fluid having flowed in from the flow inlet 1001 passes through the branched portions 1002 to 1005, and flows out of the flow outlets 1006. In this case, a fluid transport channel in a single series is shown in which the fluid having flowed in from one flow inlet 1001 is transported through the branched portions and branched channels and flows out of sixteen flow outlets 1006.

Regions where the direction of movement of the fluid is changed (hereinafter referred to as “movement direction change region”) 1007 and 1008 are present between the branched portion 1002 and the branched portions 1003.

Movement direction change regions 1009, 1010, 1011 and 1012 are also present between the branched portions 1003 and the branched portions 1004. The movement direction change region 1008 is the same as what is formed by reversing the movement direction change region 1007 right and left. The movement direction change regions 1009 and 1011 are alike, and are the same as what are formed by reversing the movement direction change regions 1010 and 1012 right and left, respectively.

The movement direction change region 1007 is described with reference to FIG. 13. That region is connected so that the center line 1014 extending in the direction of movement of the fluid in a flow channel 1013 extends along a range of a first circular arc 1017 having a radius R1, whose center is located at the center 1015, and a second circular arc 1018 having a radius R2, whose center is located at the center 1016. The first circular arc 1017 and the second circular arc 1018 are also combined so that the directions of the fluid turning along the circular arcs are opposite to each other. In addition, when defining as θ an angle at which the direction of movement of the fluid changes, the angle α11 of the first circular arc 1017 is A×θ and the angle α12 of the second circular arc 1018 is (A−1)×θ (A represents a positive integer or decimal).

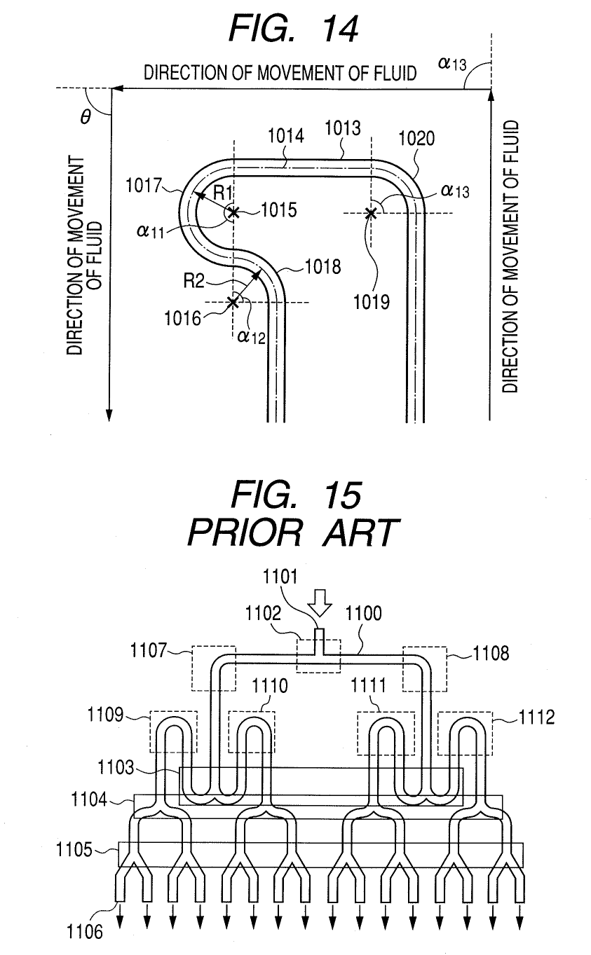

The movement direction change region 1009 is described with reference to FIG. 14. The movement direction change region 1009 is a region where a conventional curved portion and the fluid transport channel at the part described in the movement direction change region 1007 are set in combination. After the fluid has passed through the branched portion 1003, it goes through a circular arc 1020 where it changes in its movement direction at an angle of α13. Thereafter, the fluid passes through the first circular arc 1017 and the second circular arc 1018, so that it changes in its movement direction at an angle of θ. Thus, the fluid changes in its movement direction at an angle of α13+ƒ, and enters the branched portion 1014, forming a velocity distribution that is symmetrical with respect to the center line 1014 of the flow channel 1013.

In order to demonstrate the effect exhibited by the fluid transport channel of the present invention, results obtained by simulation made on the basis of fluid numerical-value calculation are explained with reference to the drawings.

FIG. 15 illustrates a conventional fluid transport channel for making a comparison with the fluid transport channel of the present invention.

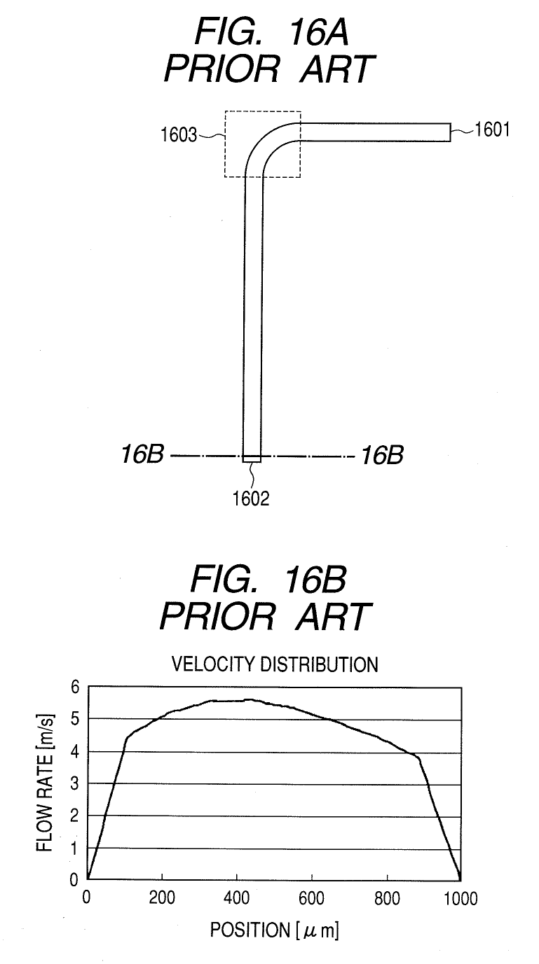

FIGS. 16A and 16B are respectively an illustration and a graph for explaining the velocity distribution of a fluid flowing through a conventional fluid transport channel.

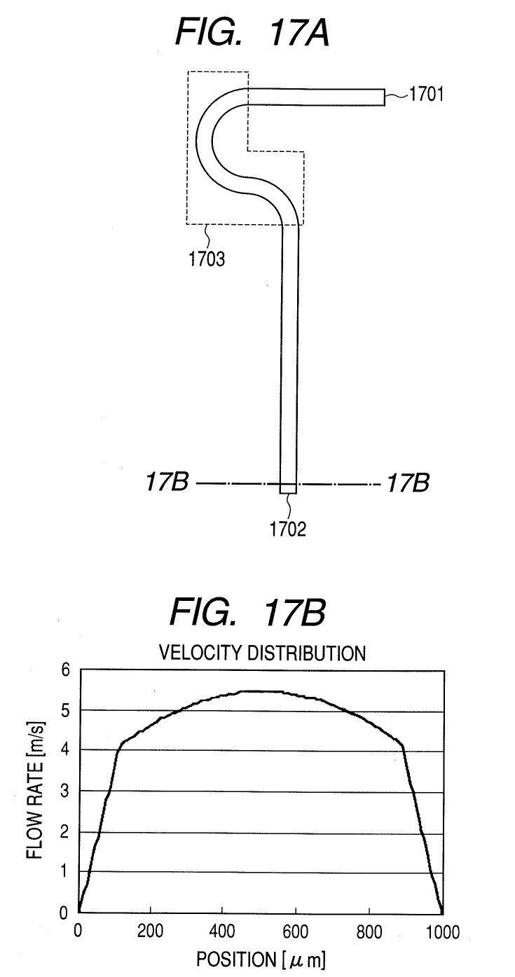

FIGS. 17A and 17B are respectively an illustration and a graph for explaining the velocity distribution of a fluid flowing through the fluid transport channel of the present invention.

The conventional fluid transport channel is described first with reference to FIG. 15.

A fluid transport channel 1100 has a flow inlet 1101 and flow outlets 1106. It also has branched portions 1102 to 1105 as in the branched portions 1002 to 1005 of the fluid transport channel shown in FIG. 12. It still also has movement direction change regions 1107 to 1112 having conventional curved portions, corresponding to the movement direction change regions 1007 to 1012 shown in FIG. 12.

Dimensions of the conventional fluid transport channel 1100 are described. The flow channel extending from the flow inlet 1101 to the flow outlets 1106 is 1.0 mm in width, which is the same as the fluid transport channel 1000 of the present invention. At the movement direction change regions 1107 and 1108, the direction of movement of the fluid is changed by 90°. At the movement direction change regions 1109 to 1112, the direction of movement of the fluid is changed by 180°. In the fluid transport channel 1100, the length of the flow channel excluding the movement direction change regions 1107 to 1112 is the same as the length of the flow channel excluding the movement direction change regions 1007 to 1012 in the fluid transport channel 100 of the present invention.

Next, dimensions of the fluid transport channel 1000 of the present invention are described. The flow channel extending from the flow inlet 1001 to the flow outlets 1006 is 1.0 mm in width. At the movement direction change regions 1007 and 1008, the angle θ at which the direction of movement of the fluid is changed is set to be 90°, and A is set to be 2. Here, the angle α11 of the first circular arc 1017 is 180°, and the angle α12 of the second circular arc 1018 is 90°. The radius R1 of the first circular arc 1017 and the radius R2 of the second circular arc 1018 are each 1.0 mm. At the movement direction change regions 1009 to 1012, the direction of movement of the fluid is changed by 1.80°. In this case, the angle α13 of the circular arc 1020 whose center is located at the center 1019 is 90°.

Next, the difference between flow rates at the flow outlets is described. When water is sent from the flow inlet 1001 or 1101 at a flow rate of 9.6 kg/s/m by mass flow rate, the difference between flow rates of the fluid having flowed out of the flow outlets 1006 or 1106 is as follows:

In both of the cases, the fluid is water, which has a density of 997.8 kg/m³ and a viscosity of 0.0012825 kg/(m·s).

First, the flow rates of the water having flowed out from the flow outlets 1106 of the conventional fluid transport channel have been found to be from 0.64 kg/s/m to 0.68 kg/s/m. In this case, the difference between flow rates is 9.8% on average.

On the other hand, the flow rates of the water having flowed out from its flow outlets 1006 of the fluid transport channel of the present invention have been found to be from 0.61 kg/s/m to 0.63 kg/s/m. In this case, the difference between flow rates is 3.9% on average.

The reason that in the fluid transport channel of the present invention, the difference between the flow rates at the flow outlets is reduced is explained below with reference to FIGS. 16A and 16B and FIGS. 17A and 17B.

FIG. 16A shows a simulation result for illustrating how the fluid flows at the movement direction change region 1107 in the conventional fluid transport channel.

FIG. 17A shows a simulation result for illustrating how the fluid flows at the movement direction change region 1007 in the fluid transport channel of the present invention.

The distances from flow inlets 1601 (FIG. 16A) and 1701 (FIG. 17A) to the positions where the direction of movement of the fluid changes are 5.0 mm. The distance from a curved portion 1603 to an outlet 1602 (FIG. 16A) and the distance from a movement direction change region 1703 to an outlet 1702 (FIG. 17A) are each 10 mm. In both of the cases, the fluid is water, which has a density of 997.8 kg/m³ and a viscosity of 0.0012825 kg/(m·s).

In FIG. 16A, the water enters the flow channel from the inlet 1601 at a flow rate of 4.8 kg/s/m, goes through the curved portion 1603 and flows out of the outlet 1602. FIG. 16B is a graph showing velocity distribution of the water at a 16B-16B cross section of the outlet 1602.

As can be seen from FIG. 16B, the velocity distribution is ill-balanced or the deviation of the velocity distribution occurs. The water having entered the flow channel from the inlet 1601 goes through the curved portion 1603, and thereafter forms velocity distribution depending on the turn direction. While the deviation of the velocity distribution is maintained, the water enters the subsequent branched portion 1103 (FIG. 15), whereupon the flow rate on the flow channel side having the movement direction change region 1109 comes larger than the flow rate on the flow channel side having the movement direction change region 1110. As in the branched portion 1103, the difference between the quantities of the divided fluids comes about also at the branched portion 1104. Thereby, the differences between the flow rates at the flow outlets 1106 become larger.

In FIG. 17A as well, the water enters the flow channel from the inlet 1701 at a flow rate of 4.8 kg/s/m, goes through the movement direction change region 1703 and flows out of the outlet 1702. FIG. 17B is a graph showing the velocity distribution of the water at a 17B-17B cross section of the outlet 1702.

As can be seen from FIG. 17B, the velocity distribution is symmetrical with respect to the center line of the flow channel. The water having entered the flow channel from the inlet 1701 acts to form velocity distribution depending on the turn direction due to the first circular arc. Next, velocity distribution resulting from the reverse turn direction due to the second circular arc is formed.

Thus, the velocity distribution symmetrical with respect to the center line of the flow channel is formed at the flow outlets 1702. As a result, the water having entered the branched portion 1003 (FIG. 12) is evenly divided. As in the movement direction change region 1007 (corresponding to 1703 in FIG. 17A), the water having passed through the movement direction change regions 1009 to 1012 also forms the velocity distribution symmetrical with respect to the center line of the flow channel. Thus, the water having entered the branched portions 1004 is substantially evenly divided. As a result, the differences between the flow rates at the flow outlets 1006 are reduced.

According to the present invention, the velocity distribution of the water which enters branched portions 1003 to 1004 can be symmetrical with respect to the center line of the flow channel, and hence the water is evenly divided at the branched portions 1003 to 1004. Thus, the differences between the flow rates of the divided fluids can be reduced, as compared with the conventional fluid transport channel.

Next, the configuration of the fluid transport channel of the present invention will be described in detail.

The range of A is described in detail the range of A is 1.8 or more and 2.2 or less, preferably 1.8 or more and 2.1 or less, and particularly preferably 2.

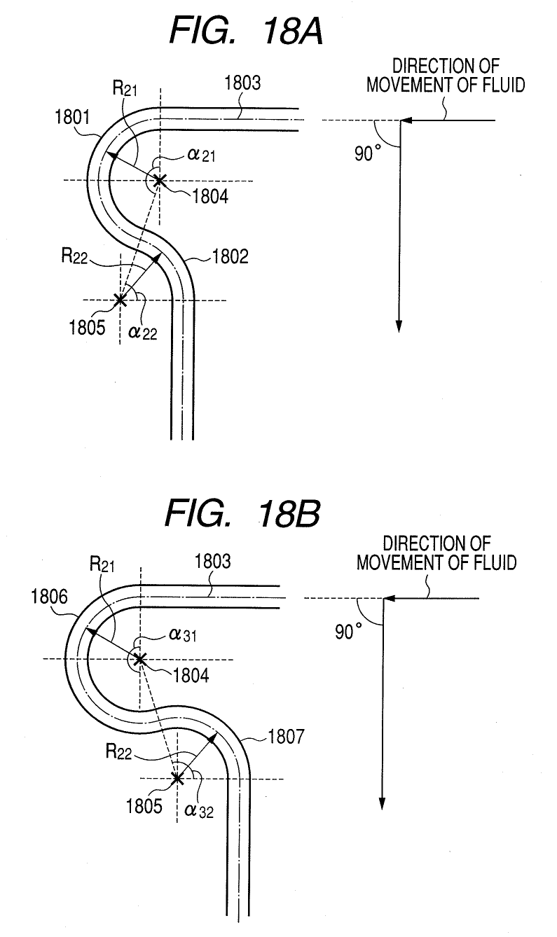

In fluid transport channels shown in FIGS. 18A and 18B, the angle at which the direction of movement of the fluid is changed is 90°. The flow channel has a width of 1.0 mm, and the radius R21 of the first circular arc 1801 and the radius R22 of the second circular arc 1802 are both 1.0 mm. The first circular arc 1801 and the second circular arc 1802 are continuously combined.

FIG. 18A is a view showing a case where the value of A is 1.8. The first circular arc 1801 whose center is located at the center 1804 has an angle α21 of 162°, and the second circular arc 1802 whose center is located at the center 1805 has an angle α22 of 72°. Reference numeral 1803 denotes the center line.

FIG. 18B is a view showing a case where the value of A is 2.2. The first circular arc 1806 has an angle α31 of 198°, and the second circular arc 1807 has an angle α32 of 108°.

In both of the cases, the velocity distribution of the fluid is symmetrical with respect to the center line of the flow channel, and hence the fluid is substantially evenly divided at the branched portions positioned downstream. The effect of the present invention is remarkable when the value of A is in the range of 1.8 or more and 2.2 or less. However, the effect of the present invention is obtainable also when the value of A is outside that range. The ratio of R21 to R22 may be in the range of 0.5 or more and 1.5 or less. The flow channel may be provided, between the first circular arc 1801 and the second circular arc 1802, with a straight-line portion having a length of 1/10 or less of the diameter of the flow channel.

The ratio of the radius R1 of the first circular arc to the radius R2 of the second circular arc is described in detail.

The ratio of R1 and the R2 is 0.5 or more and 1.5 or less, preferably 0.7 or more and 1.25 or less, and particularly preferably 1.

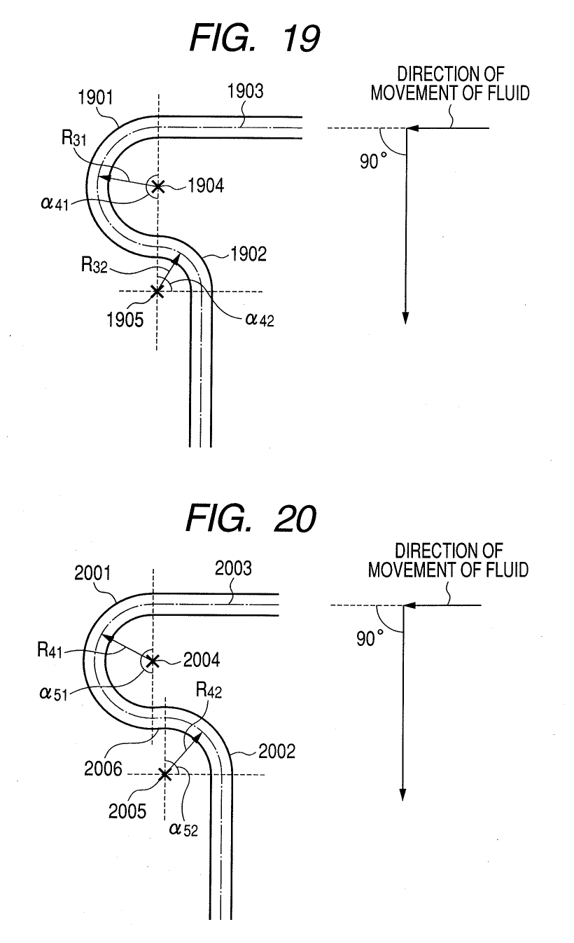

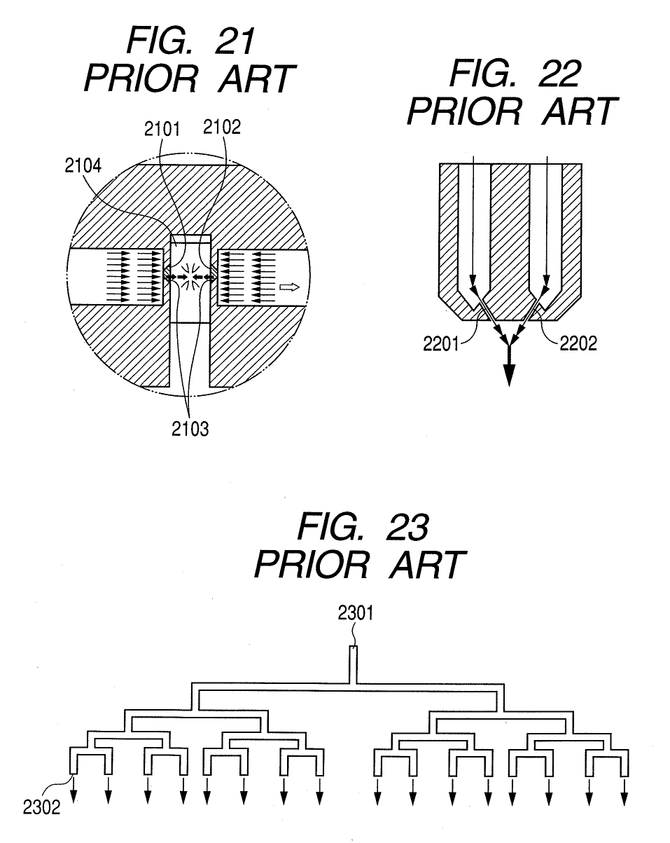

In FIG. 19, the angle at which the direction of movement of the fluid is changed is 90°. The first circular arc 1901 whose center is located at the center 1904 has a radius R31 of 1.0 mm, and the second circular arc 1902 whose center is located at the center 1905 has a radius R32 of 0.8 mm. The first circular arc 1901 has an angle α41 of 180°, and the second circular arc 1902 has an angle α42 of 90°. The first circular arc 1901 and the second circular arc 1902 are combined continuously. Reference numeral 1903 denotes the center line.

Here, the velocity distribution of the fluid is symmetrical with respect to the center line of the flow channel, and hence the fluid is substantially evenly divided at the branched portions positioned downstream. The effect of the present invention is remarkable when the ratio of R31 to R32 is in the range of 0.5 or more and 1.5 or less. However, the effect of the present invention is obtainable also when the ratio is outside that range. The value of A may be in the range of 1.8 or more and 2.2 or less. The flow channel may be provided, between the first circular arc 1901 and the second circular arc 1902, with a straight-line portion having a length of 1/10 or less of the diameter of the flow channel.

It is preferable that the first circular arc and the second circular arc are continuously combined. However, the flow channel may have a straight-line portion having a length of 1/10 or less of the diameter of the flow channel that forms the circular arcs.

FIG. 20 shows a flow channel provided with a straight-line portion 2006 between the first circular arc 2001 whose center is located at the center 2004 and the second circular arc 2002 whose center is located at the center 2005. Reference numeral 2003 denotes the center line.

In the fluid transport channel shown in FIG. 20, the angle at which the direction of movement of the fluid is changed is 90°. The first circular arc 2001 has a radius R41 of 1.0 mm, and the second circular arc 2002 has a radius R42 of 1.0 mm. The first circular arc 1901 has an angle α51 of 180°, and the second circular arc 1902 has an angle α52 of 90°. The flow channel has a width of 1.0 mm and has the straight-line portion of 0.1 mm in length.

In this case, the velocity distribution of the fluid is symmetrical with respect to the center line of the flow channel, and hence the fluid is substantially evenly divided at the branched portions positioned downstream. The value of A may be in the range of 1.8 or more and 2.2 or less, and the ratio of R41 to R42 may be in the range of 0.5 or more and 1.5 or less.

Dimensions of the flow channel in the fluid transport channel of the present invention are described.

The width of the flow channel is not particularly limited, but is preferably in the range of 0.01 mm or more and 1,000 mm or less, more preferably 0.05 mm or more and 100 mm or less, and particularly preferably 0.1 mm or more and 10 mm or less.

The depth of the flow channel is not particularly limited, but is preferably in the range of 0.01 mm or more and 1,000 mm or less, more preferably 0.05 mm or more and 100 mm or less, and particularly preferably 0.1 mm or more and 10 mm or less.

In the present invention, the higher the flow velocity of the fluid is, the more effective. Accordingly, it is appropriate for the fluid to have a flow velocity of 0.1 m/s or more, preferably 0.5 m/s or more, and particularly preferably 1 m/s or more.

The fluid used in the present invention may be used without regard to its viscosity. However, in general, as the viscosity of a fluid increases, the pressure loss increases when the fluid passes through the fluid transport channel. Accordingly, it is desirable for the flow channel to have a large sectional area when the fluid to be transported has a high viscosity.

In the fluid transport channel of the present invention, the sectional shape of the flow channel is not particularly limited, and may be polygonal, circular, semicircular or elliptic.

### EXAMPLES

The present invention is described below in greater detail by way of Examples.

### Example 1

The fluid processing apparatus of the present invention is described with reference to the drawings.

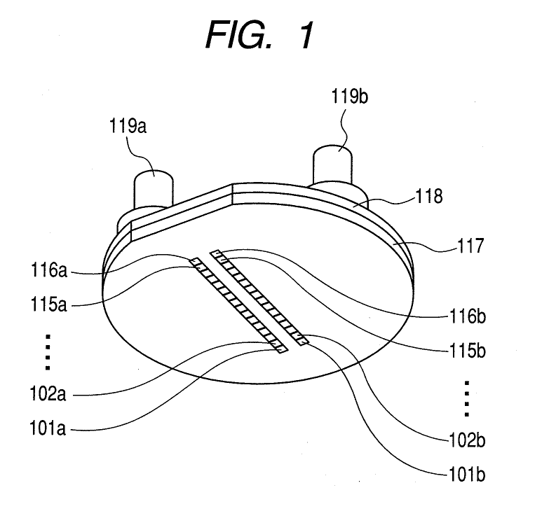

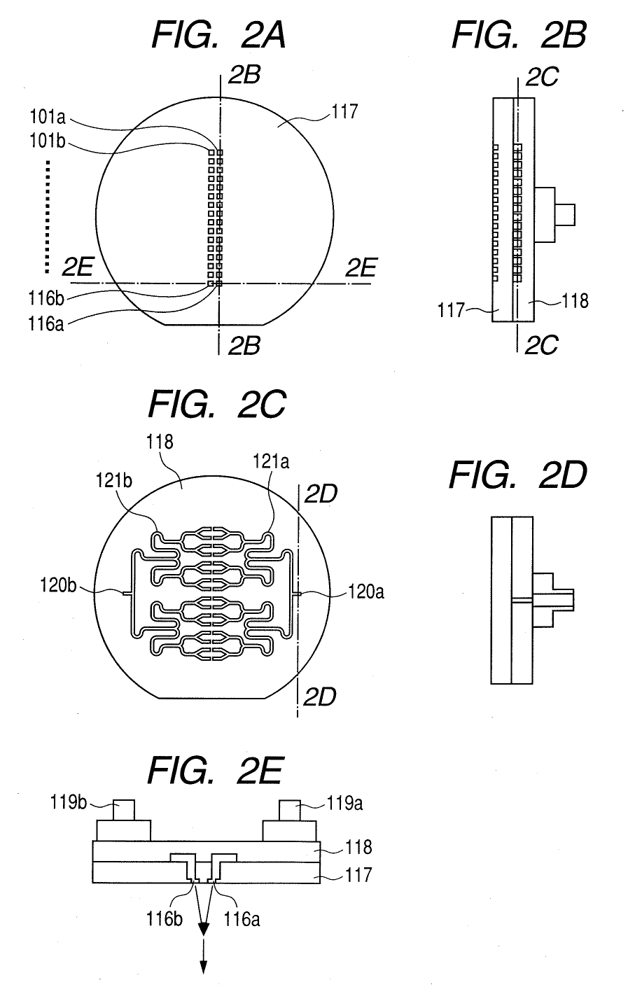

FIG. 1 is a perspective view showing a fluid processing apparatus of the present invention. FIG. 2A is an illustration of the fluid processing apparatus in this Example as viewed from its bottom side. FIG. 2B is a sectional view taken along the line 2B-2B in FIG. 2A. FIG. 2C is a sectional view taken along the line 2C-2C in FIG. 2B. FIG. 2D is a sectional view taken along the line 2D-2D in FIG. 2C. FIG. 2E is a sectional view taken along the line 2E-2E in FIG. 2A.

An array type micro-mixer in this Example is produced by superimposing a fluid dividing flow channel substrate 118 and a nozzle substrate 117 one on the other. Reference numerals 101a to 116a and 101b to 116b denote nozzles formed in the nozzle substrate 117. Reference numerals 119a and 119b denote tube connectors.

In the fluid dividing flow channel substrate 118 and the nozzle substrate 117, fluid dividing flow channels 121a and 121b and the above nozzles are formed by etching silicon substrates vertically from both sides of each of the substrates.

The nozzles 101a to 116a and 101b to 116b formed in the nozzle substrate 117 are formed by connecting holes etched from one side and holes etched from the other side, where the holes are so set up that their centers of gravity are out of alignment with one another. With such set-up, the fluid jetting out of the respective nozzles jets out not vertically to the substrate but at a certain angle thereto.

Then, the nozzles 101a to 116a and the nozzles 101b to 116b are so arranged that their respective jet-out directions cross one another. The respective groups of nozzles make up mixing units.

The tube connectors 119a and 119b are made by processing stainless steel, and are bonded with an adhesive to the fluid dividing flow channel substrate 118.

Referring to the fluid dividing flow channel, fluid dividing flow channels 121a and 121b are each the same as the fluid dividing flow channel 1000 described in the column of BEST MODES FOR PRACTICING THE INVENTION. The fluid dividing flow channels 121a and 121b are each 0.8 mm in depth.

It is described below how the fluid processing apparatus in this Example operates. A fluid is allowed to flow in from the tube connector 119a by means of a pump, where the fluid flows into the flow channel from a flow inlet 120a, and is divided into sixteen flows in the fluid dividing flow channel 121a formed in the fluid dividing flow channel substrate 118. Then, the fluid thus divided jets out of the nozzles 101a to 116a formed in the nozzle substrate 117. A fluid having flowed in from the tube connector 119b also jets out of the nozzles 101b to 116b entirely in the same way.

Since the nozzles 101a to 116a and the nozzles 101b to 116b are so arranged that their jet-out directions cross one another, both the fluids having jetted out collide with each other to mix or react at the collision part.

According to this Example, the velocity distribution of the fluid flowing through each fluid dividing flow channel is symmetrical with respect to the center line of the flow channel, and hence the fluid is substantially evenly divided at the branched portions. As a result, a difference in the flow rate of the fluid fed to each nozzle is reduced, and thus the uniformity of mixing or reaction can be improved.

### Example 2

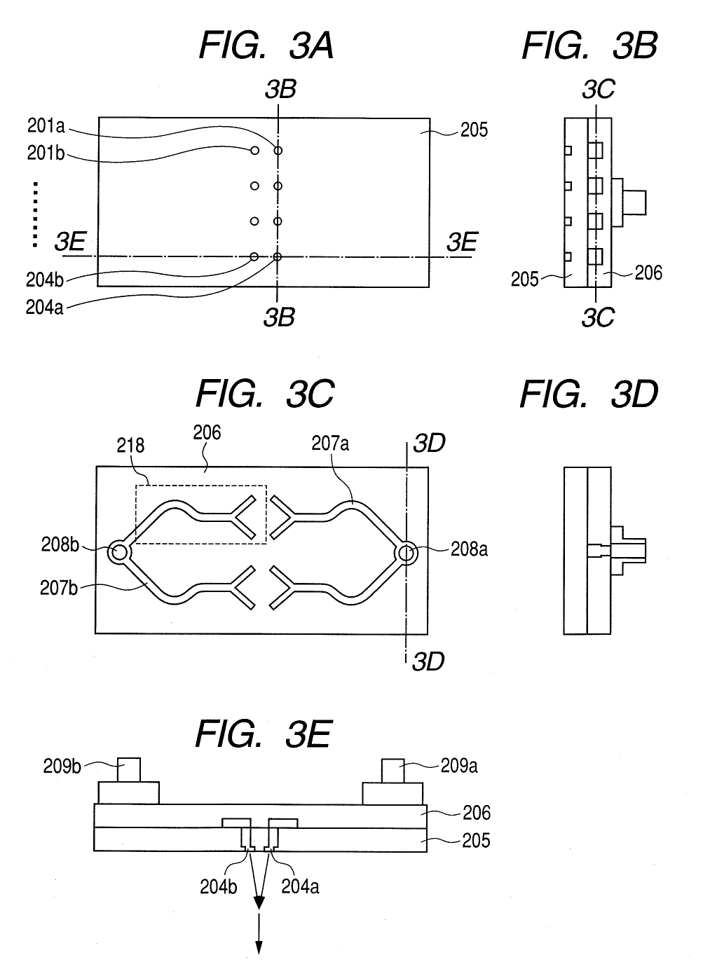

FIGS. 3A to 3E are illustrations for explaining a fluid processing apparatus of Example 2 in the present invention.

FIG. 3A is an illustration of the fluid processing apparatus in Example 2 as viewed from its bottom side. FIG. 3B is a sectional view taken along the line 3B-3B in FIG. 3A. FIG. 3C is a sectional view taken along the line 3C-3C in FIG. 3B. FIG. 3D is a sectional view taken along the line 3D-3D in FIG. 3C. FIG. 3E is a sectional view taken along the line 3E-3E in FIG. 3A.

An array type micro-mixer of this Example is produced by superimposing a fluid dividing flow channel substrate 206 and a nozzle substrate 205 one on the other. Reference numerals 201a to 204a and 201b to 204b denote nozzles formed in the nozzle substrate 205. Reference numerals 209a and 209b denote tube connectors.

In the fluid dividing flow channel substrate 206, fluid dividing flow channels 207a and 207b and flow inlets 208a and 208b are formed by etching a silicon substrate vertically from both sides of the substrate.

The nozzles 201a to 204a and 201b to 204b formed in the nozzle substrate 205 are formed by connecting holes etched from one side and holes etched from the other side, where the holes are so set up that their centers of gravity are out of alignment with one another. With such set-up, the fluid jetting out of the respective nozzles jets out not vertically to the substrate but at a certain angle thereto.

Then, the nozzles 201a to 204a and the nozzles 201b to 204b are so arranged that their respective jet-out directions cross one another. The respective groups of nozzles make up mixing units.

The tube connectors 209a and 209b are made by processing stainless steel, and are bonded with an adhesive to the fluid dividing flow channel substrate 206.

The fluid dividing flow channel in this Example is described with reference to FIG. 4. FIG. 4 is an enlarged view of a region 218 shown in FIG. 3C. This region is so connected that the center line 211 extending in the direction of movement of the fluid inside a flow channel 210 extends along a range of a first circular arc 212 having a radius R21, whose center is located at the center 213, and a second circular arc 214 having a radius R22, whose center is located at the center 215.

The first circular arc 212 and the second circular arc 214 are also so combined that the directions of the fluid turning along the circular arcs are opposite to each other. In addition, where the angle at which the direction of movement of the fluid changes is defined as θ2, the first circular arc 212 has an angle α21 of A×θ2 and the second circular arc 214 has an angle α22 of (A−1)×θ2 (A represents a positive integer or decimal).

A fluid dividing flow channel 207b (FIG. 3C) is a flow channel in which the portion illustrated in the region 218 and a portion formed by reversing the former portion are in combination. A fluid dividing flow channel 207a is a flow channel formed by reversing the fluid dividing flow channel 207b.

In this Example, the direction of movement of the fluid is changed by 45°. When the value of A is 2, the first circular arc 212 has an angle α21 of 90°, and the second circular arc 214 has an angle α22 of 45°. Their radii are R21=R22=1.0 mm. The velocity distribution of the fluid entering a branched portion 216 is symmetrical with respect to the center line of the flow channel, and hence the fluid is evenly divided to flow outlets 217a and 217b.

It is described below how the fluid processing apparatus of this Example operates. A fluid is allowed to flow in from the tube connector 209a by means of a pump, where the fluid flows into the flow channel from a flow inlet 208a, and is divided into four flows in the fluid dividing flow channel 207a formed in the fluid dividing flow channel substrate 206. The fluid thus divided jets out of the nozzles 201a to 204a formed in the nozzle substrate 205. A fluid having flowed in from a flow inlet 208b jets out of the nozzles 201b to 204b entirely in the same way.

Since the nozzles 201a to 204a and the nozzles 201b to 204b are so arranged that their jet-out directions cross one another, both the fluids having jetted out collide with each other to mix or react at the collision part.

According to this Example, the velocity distribution of the fluid entering the branched portions is symmetrical with respect to the center line of the flow channel, and hence the fluid is substantially evenly divided at the branched portions. As a result, a difference in the flow rate of the fluid fed to each nozzle is reduced, and hence the uniformity of mixing or reaction can be improved.

### Example 3

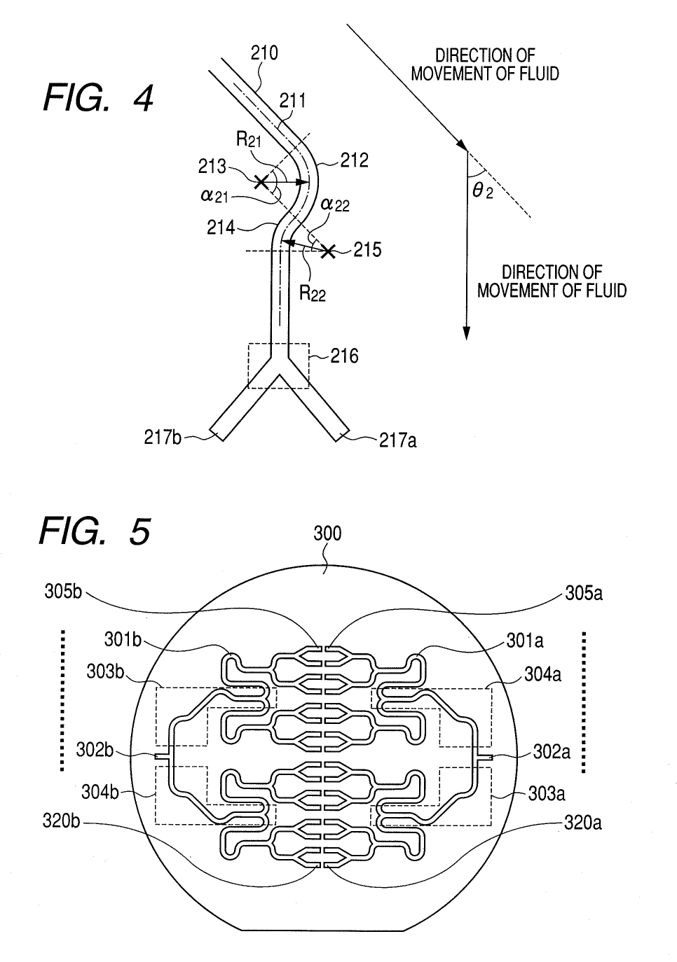

FIG. 5 illustrates a fluid processing apparatus in Example 3 of the present invention. In this Example, the fluid processing apparatus is produced in the same way as in Example 1 by superimposing a fluid dividing flow channel substrate and a nozzle substrate one on the other and connecting tube connectors thereto.

In a fluid dividing flow channel substrate 300, fluid dividing flow channels 301a and 301b are formed by etching a silicon substrate vertically from one side of the substrate.

Fluid passes from flow inlets 302a and 302b through movement direction change regions 303a and 303b and 304a and 304b, and jet out of nozzles through flow outlets 305a to 320a and 305b to 320b.

Other portions of the flow channels function as in Example 1 except for the movement direction change regions 303a and 303b and 304a and 304b. Accordingly, it is described here how the movement direction change regions 303a and 303b and 304a and 304b function.

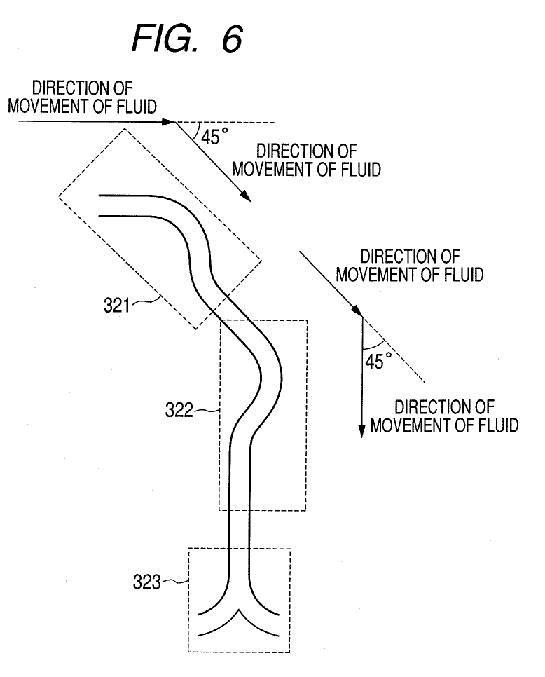

FIG. 6 is an enlarged view of the movement direction change region 303a. The movement direction change region 303a is made up of a combination of the first and second movement direction change regions 321 and 322 where the direction of movement of the fluid is changed by 45°.

The fluid having flowed into the flow channel from the flow inlet 302a is first changed in its movement direction by 45°. The first movement direction change region 321 is made up of a first circular arc in which the direction is changed by 90° and a second circular arc in which the direction is changed by 45° which are continuously combined.

Thus, the fluid having passed through the first movement direction change region 321 forms the velocity distribution that is symmetrical with respect to the center line of the flow channel. Likewise, the fluid having passed through the second movement direction change region 322 is changed in its movement direction by 45° and thereafter forms the velocity distribution that is symmetrical with respect to the center line of the flow channel.

Thus, the fluid is substantially evenly divided at a branched portion 323.

In this Example as well, a difference in the flow rate of the fluid divided to each nozzle can be reduced, and hence the uniformity of mixing or reaction can be improved.

### Example 4

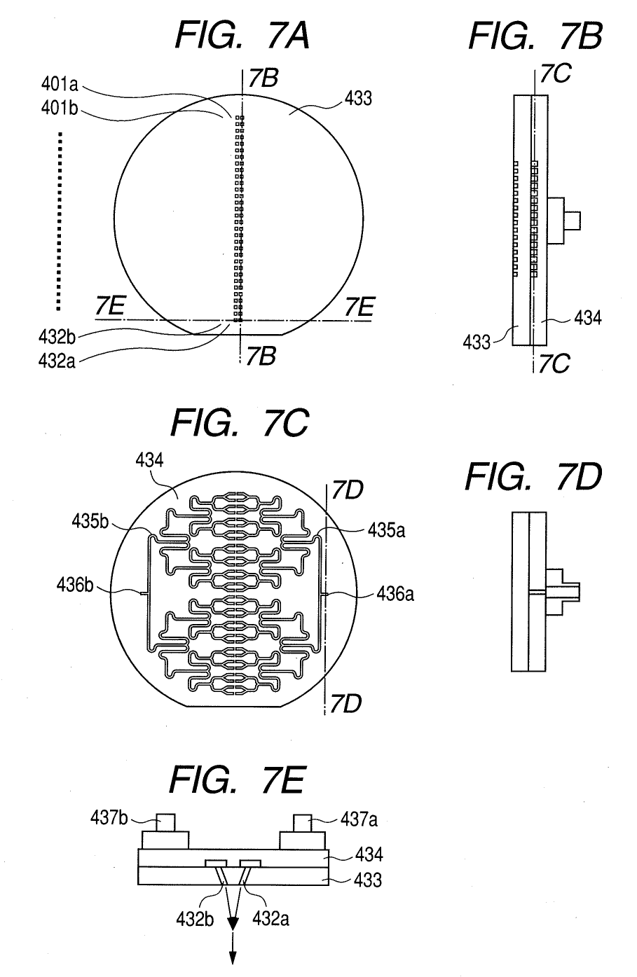

FIGS. 7A to 7E are illustrations for explaining a fluid processing apparatus in Example 4 of the present invention.

FIG. 7A is an illustration of the fluid processing apparatus in Example 4 as viewed from its bottom side. FIG. 7B is a sectional view taken along the line 7B-7B in FIG. 7A. FIG. 7C is a sectional view taken along the line 7C-7C in FIG. 7B. FIG. 7D is a sectional view taken along the line 7D-7D in FIG. 7C. FIG. 7E is a sectional view taken along the line 7E-7E in FIG. 7A.

An array type micro-mixer of this Example is produced by superimposing a fluid dividing flow channel substrate 434 and a nozzle substrate 433 one on the other. Reference numerals 401a to 432a and 401b to 432b denote nozzles formed in the nozzle substrate 433. Reference numerals 437a and 437b denote tube connectors.

In the fluid dividing flow channel substrate 435, fluid dividing flow channels 435a and 435b and flow inlets 436a and 436b are formed by etching a silicon substrate vertically from both sides of the substrate.

The nozzle substrate 433 is made of a glass plate, and the nozzles 401a to 432a and 401b to 432b formed therein by making oblique holes as shown in FIG. 7E through laser processing. With such set-up, the fluid jetting out of the respective nozzles jets out at a certain angle thereto.

The nozzles 401a to 432a and the nozzles 401b to 432b are so arranged that their respective jet-out directions cross one another. The respective groups of nozzles make up mixing units.

The tube connectors 437a and 437b are made by processing stainless steel, and are bonded with an adhesive to the fluid dividing flow channel substrate 434.

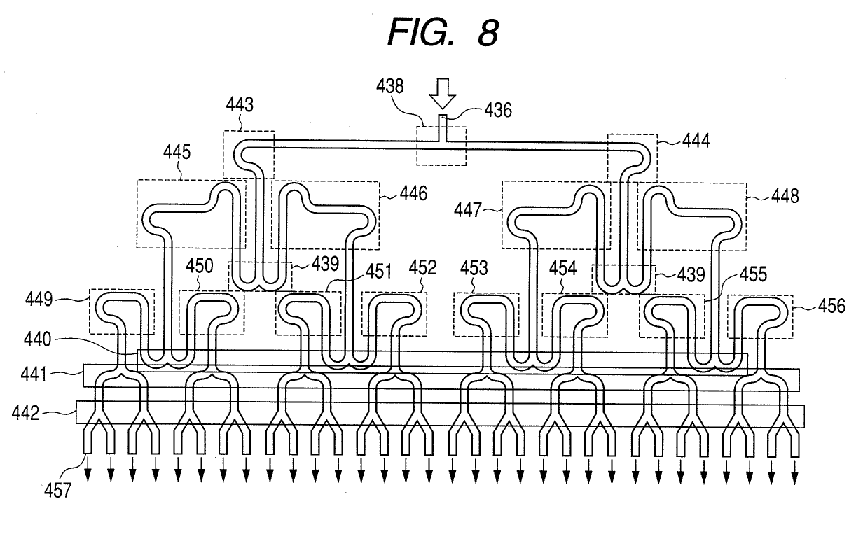

Next, the fluid dividing flow channel 435 formed in the fluid dividing flow channel substrate 434 is described. FIG. 8 is an enlarged view of the fluid dividing flow channels 435a or 435b shown in FIG. 7C. As shown in FIG. 8, a flow inlet 439 and a branched portion 438 are connected.

The branched portion 438 branches off into two ways, and outlets of the branched portion 438 are connected to inlets of branched portions 439. The branched portions 439 each further branch off into two ways, and outlets of the branched portions 439 are connected to inlets of branched portions 440.

Outlets of the branched portions 440 are connected to inlets of branched portions 441. Outlets of the branched portions 441 are also connected to inlets of branched portions 442. Outlets of branched portions 442 are connected to flow outlets 457. The fluid having flowed into the flow channel from the flow inlet 436 passes through the branched portions 439 to 442, and flows out of the flow outlets 457.

Movement direction change regions 443 and 444 are present between the branched portion 438 and the branched portion 439. Movement direction change regions 445 to 448 are present between the branched portions 439 and branched portions 440. Movement direction change regions 449 to 456 are present between the branched portions 440 and branched portions 441.

The movement direction change regions 443 and 444 and the movement direction change regions 449 to 456 function as in Example 1. Accordingly, it is described here how the movement direction change regions 445 to 448 function.

The movement direction change regions 445 to 448 are regions in which the direction of movement of the fluid is changed by 180°.

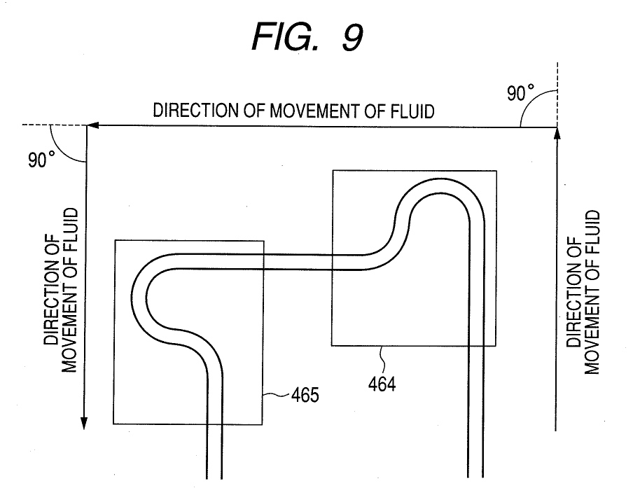

In this Example, two of the fluid dividing flow channel which changes the direction of movement of the fluid change by 90° as described in the column of BEST MODES FOR PRACTICING THE INVENTION is provided in combination to change the direction of movement of the fluid change by 180°. This is described in detail with reference to FIG. 9.

FIG. 9 is an enlarged view of the movement direction change region 445. The fluid having passed through the branched portion 439 and entered this region is changed in its movement direction by 90° at a first movement direction change region 464. The first movement direction change region 464 is made up of the first circular arc in which the direction is changed by 180° and the second circular arc in which the direction is changed by 90° which are continuously combined.

Thus, the fluid having passed through the first movement direction change region 464 forms the velocity distribution that is symmetrical with respect to the center line of the flow channel. Likewise, the fluid having passed through the second movement direction change region 465 is changed in its movement direction by 90° and thereafter forms the velocity distribution that is symmetrical with respect to the center line of the flow channel.

Thus, the fluid is evenly divided at the branched portion 440.

It is described below how the fluid processing apparatus of this Example operates. A fluid is allowed to flow in from the tube connector 437a by means of a pump, where the fluid flows into the flow channel from the flow inlet 436a, and is divided into thirty two flows in the fluid dividing flow channel 435a formed in the fluid dividing flow channel substrate 434. The fluid thus divided jets out of the nozzles 401a to 432a formed in the nozzle substrate 433. A fluid having flowed in from the flow inlet 436b jets out of the nozzles 401b to 432b entirely in the same way.

Since the nozzles 401a to 432a and the nozzles 401b to 432b are so arranged that their jet-out directions cross one another, both the fluids having jetted out collide with each other to mix or react at the collision part.

In this Example as well, a difference in the flow rate of the fluid divided to each nozzle can be reduced, and hence the uniformity of mixing or reaction can be improved.

### Example 5

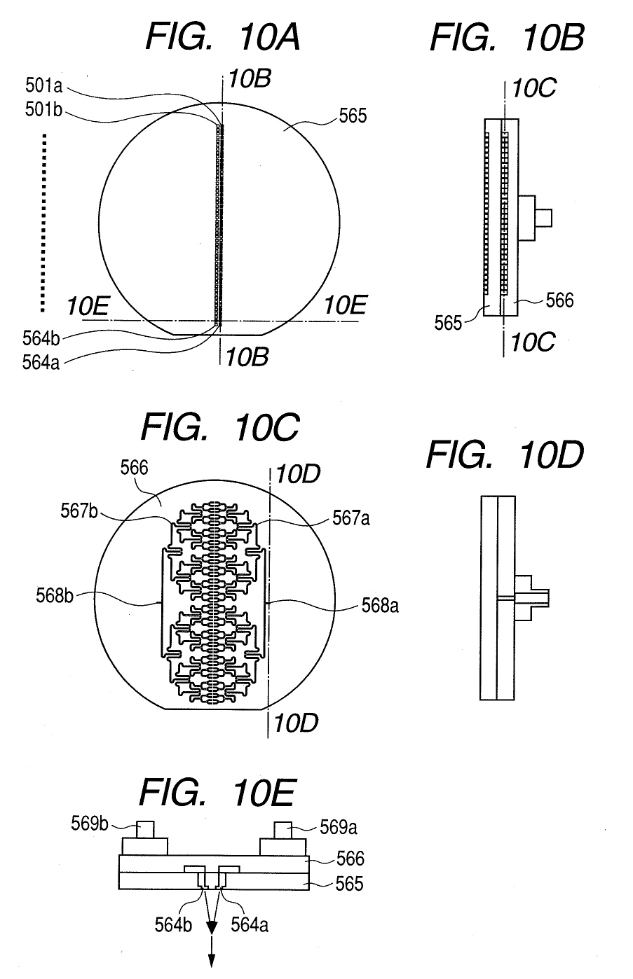

FIGS. 10A to 10E are illustrations for explaining a fluid processing apparatus in Example 5 of the present invention.

FIG. 10A is an illustration of the fluid processing apparatus in Example 5 as viewed from its bottom side. FIG. 10B is a sectional view taken along the line 10B-10B in FIG. 10A. FIG. 10C is a sectional view taken along the line 10C-10C in FIG. 10B. FIG. 10D is a sectional view taken along the line 10D-10D in FIG. 10C. FIG. 10E is a sectional view taken along the line 10E-10E in FIG. 10A.

An array type micro-mixer in this Example is produced by superimposing a fluid dividing flow channel substrate 566 and a nozzle substrate 565 one on the other. Reference numerals 501a to 564a and 501b to 564b denote nozzles formed in the nozzle substrate 566. Reference numerals 569a and 569b denote tube connectors.

In the fluid dividing flow channel substrate 566, fluid dividing flow channels 567a and 567b and flow inlets 568a and 568b are formed by etching a silicon substrate vertically from both sides of the substrate.

The nozzles 501a to 564a and 501b to 564b formed in the nozzle substrate 565 are formed by connecting holes etched from one side and holes etched from the other side, where the holes are so set up that their centers of gravity are out of alignment with one another. With such set-up, the fluid jetting out of the respective nozzles jets out not vertically to the substrate but at a certain angle thereto. The nozzles 501a to 564a and the nozzles 501b to 564b are so arranged that their respective jet-out directions cross one another. The respective groups of nozzles make up mixing units.

The tube connectors 569a and 569b are made by processing stainless steel, and are bonded with an adhesive to the fluid dividing flow channel substrate 566.

The fluid dividing flow channels 567a and 567b are described here. The fluid dividing flow channels 567a and 567b are made up of two sets of the fluid dividing flow channels 435a and 435b described in Example 4 which are combined in parallel. Their respective movement direction change regions function as in the movement direction change regions in Example 4.

It is described below how the fluid processing apparatus of this Example operates.

A fluid is allowed to flow in from the tube connector 569a by means of a pump, where the fluid flows into the flow channel from the flow inlet 568a, and is divided into sixty four flows in the fluid dividing flow channel 567a formed in the fluid dividing flow channel substrate 566. The fluid thus divided jets out of the nozzles 501a to 564a formed in the nozzle substrate 565. A fluid having flowed in from the flow inlet 568b jets out of the nozzles 501b to 564b entirely in the same way.

Since the nozzles 501a to 564a and the nozzles 501b to 564b are so arranged that their jet-out directions cross one another, both the fluids having jetted out collide with each other to mix or react at the collision part.

In this Example as well, a difference in the flow rate of the fluid-divided to each nozzle can be reduced, and hence the uniformity of mixing or reaction can be improved.

### Example 6

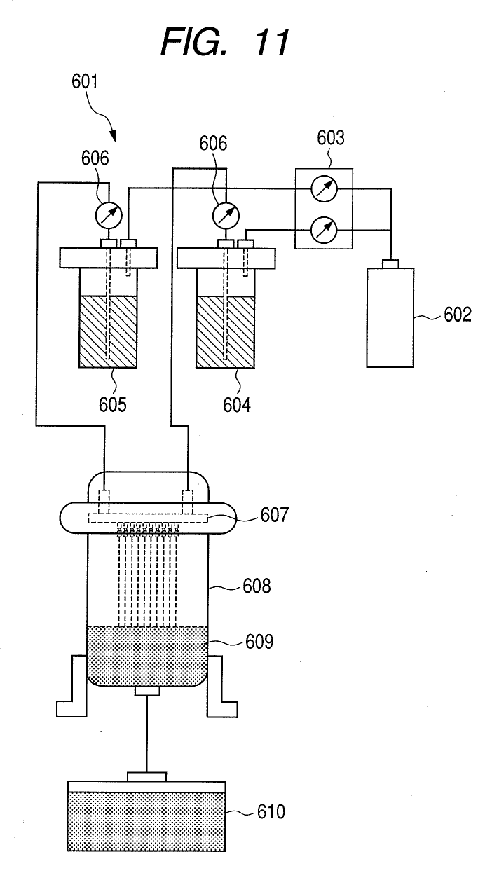

FIG. 11 is a conceptual diagram showing a fluid processing system in Example 6 of the present invention.

Reference numeral 601 denotes the fluid processing system of the present invention. Reference numeral 602 denotes high-pressure gas for transporting the fluid, and reference numeral 603 denotes a regulator as a fluid control means for controlling transport pressure. Reference numerals 604 and 605 denote a first reaction liquid tank and a second reaction liquid tank, respectively, as feed fluid storage means which store reaction liquids. Reference numeral 606 denotes flow meters for monitoring flow rates of the reaction liquids, and reference numeral 610 denotes a collection tank as a flowed fluid storage unit which collects a reaction product. A reaction vessel 608 is incorporated with such a fluid processing apparatus 607 as described in Example 5.

An actual example is described in which the fluid processing system in this Example is utilized to produce a dispersion of a magenta pigment in a large quantity.

A pigment solution and ion-exchange water are stored in the first reaction liquid tank 604 and the second reaction liquid tank 605, respectively, at room temperature. It is described below how to prepare the pigment solution used in this example.

To 10 parts of a quinacridone pigment, C.I. Pigment Red 122, 100 parts of dimethyl sulfoxide is added and suspended. Subsequently, 40 parts of polyoxyethylene lauryl ether as a dispersing agent is added, and an aqueous 25% sodium hydroxide solution is added until these are dissolved, to thereby prepare the first reaction liquid. The respective reaction liquids are transported to the reaction vessel 608 by the aid of pressure of the high-pressure gas 602.

In this case, flow rate meters 606 are monitored and the regulators 603 are controlled, thereby regulating the flow rates of the reaction liquids. Thus, the pigment solution and the ion-exchange water are jetted out at a flow rate of 7 m/s and at a flow rate of 3 m/s, and crosswise collide with each other to mix in the reaction vessel 608 provided beneath the fluid processing apparatus 607. As a result, a magenta pigment dispersion 609 is formed and collected in the collection tank 610.

### Example 7

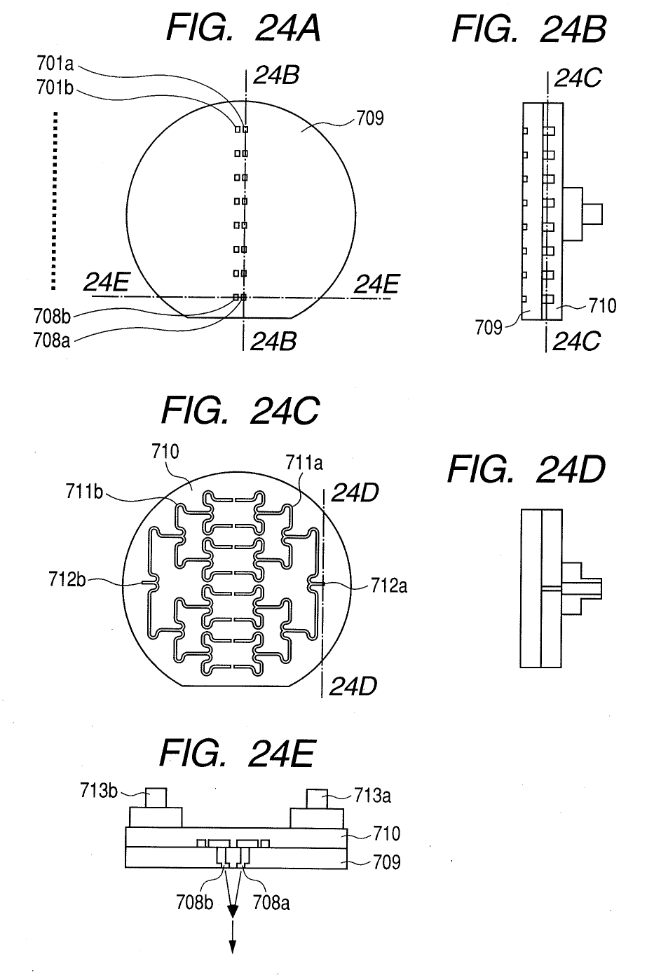

FIGS. 24A to 24E are illustrations for explaining a fluid processing apparatus in Example 7 of the present invention.

FIG. 24A is an illustration of the fluid processing apparatus of Example 7 as viewed from its bottom side. FIG. 24B is a sectional view taken along the line 24B-24B in FIG. 24A. FIG. 24C is a sectional view taken along the line 24C-24C in FIG. 24B. FIG. 24D is a sectional view taken along the line 24D-24D in FIG. 24C. FIG. 24E is a sectional view taken along the line 24E-24E in FIG. 24A.

An array type micro-mixer in this Example is produced by superimposing a fluid dividing flow channel substrate 710 and a nozzle substrate 709 one on the other. Reference numerals 701a to 708a and 701b to 708b denote nozzles formed in the nozzle substrate 709. Reference numerals 713a and 713b denote tube connectors.

In the fluid dividing flow channel substrate 710, fluid dividing flow channels 711a and 711b and flow inlets 712a and 712b are respectively formed by etching a silicon substrate vertically from both sides of the substrate.

The nozzles 701a to 708a and 701b to 708b formed in the nozzle substrate 709 are formed by connecting holes etched from one side and holes etched from the other side, where the holes are so set up that their centers of gravity are out of alignment with one another. With such set-up, the fluid jetting out of the respective nozzles jets out not vertically to the substrate but at a certain angle thereto. The nozzles 701a to 708a and the nozzles 701b to 708b are so arranged that their respective jet-out directions cross one another. The respective groups of nozzles make up mixing units.

The tube connectors 713a and 703b are made by processing stainless steel, and are bonded with an adhesive to the fluid dividing flow channel substrate 710.

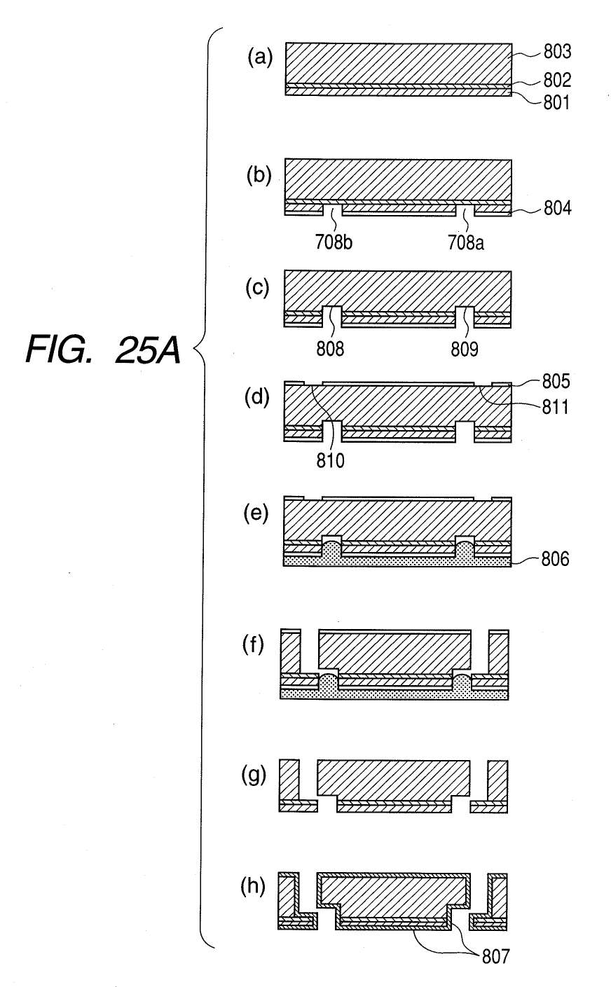

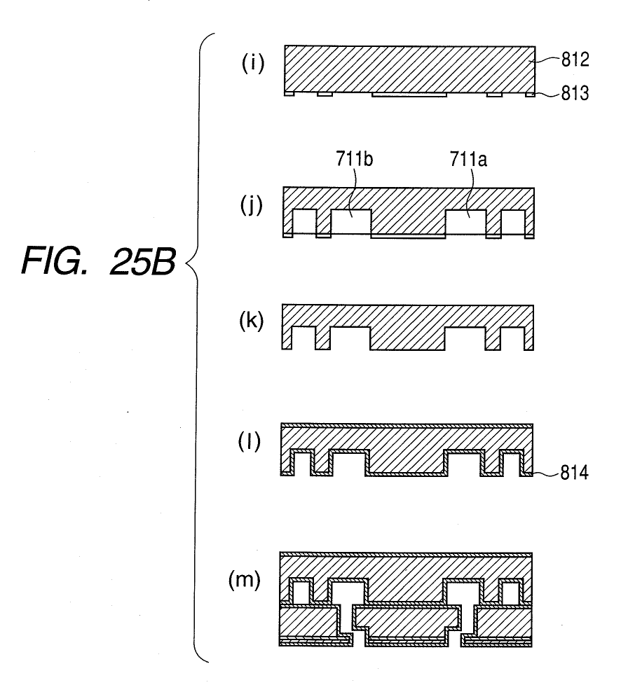

Next, the steps of producing the fluid processing apparatus in this Example are described. FIG. 25A and FIG. 25B illustrate a process for producing the fluid processing apparatus by means of cross sections taken along the line 24E-24E in FIG. 24A.

An SOI (silicon on insulator) substrate used for the nozzle substrate 709 is described first. In the SOI substrate, an active layer 801 has a thickness of 25 μm, a silicon oxide layer 802 has a thickness of 0.5 μm and a support substrate layer 803 has a thickness of 200 μm [(a) of FIG. 25A].

First, on the side of the active layer 801, a pattern of jet-out openings 708b and 708a is formed by photolithography using a photoresist 804. Next, using the photoresist 804 as an etching mask, the active layer 801 is subjected to dry etching with plasma of SF₆ gas and C₄F₈ gas to form jet-out openings of 25 μm in depth [(b) of FIG. 25A].

Next, the silicon oxide layer 802 is removed with BHF (buffered hydrofluoric acid), followed by dry etching with plasma of SF₆ gas and C₄F₈ gas to form connecting areas 808 and 809 of 50 μm in depth [(c) of FIG. 25A].

Next, on the side of the support substrate layer 803, a pattern of lead-in openings 810 and 811 is formed by photolithography using a photoresist 805 [(d) of FIG. 25A].

Next, on the side of the active layer 801, a photoresist 806 is formed in a thickness of 15 μm. This is to protect the pattern of the jet-out openings [(e) of FIG. 25A].

Next, from the side of the support substrate layer 803 (the side on the back of the previously etched surface), etching is carried out using plasma of SF₆ gas and C₄F₈ gas, whereby dry etching is carried out up to the etching stopper silicon oxide layer 802 [(f) of FIG. 25A].

Next, the photoresist 806 is removed by O₂ plasma treatment, and thereafter the resultant substrate is washed with a mixed solution of sulfuric acid and hydrogen peroxide water at a temperature of 110° C. [(g) of FIG. 25A].

Finally, a silicon nitride film 807 is formed by low-pressure chemical vapor deposition (LPCVD) [(h) of FIG. 25A].

Next, the steps of making the fluid dividing flow channel substrate 710 are described with reference to FIG. 25B. First, a silicon substrate 812 is prepared. A pattern of fluid dividing flow channels 711b and 711a is formed by using a photoresist 813. Then, using the photoresist 813 as an etching mask, the silicon substrate 812 is subjected to dry etching with plasma of SF₆ gas and C₄F₈ gas to form fluid dividing flow channels of 800 μm in depth [(i) and (j) of FIG. 25A].

Next, the photoresist 813 is removed by O₂ plasma treatment, and thereafter the resultant substrate is washed with a mixed solution of sulfuric acid and hydrogen peroxide water at a temperature of 110° C. [(k) of FIG. 25A].

Finally, a silicon nitride film 814 is formed by LPCVD [(l) of FIG. 25A].

The nozzle substrate 709 and fluid dividing flow channel substrate 710 made in the manner described above are joined by substrate-substrate direct joining [(m) of FIG. 25A].

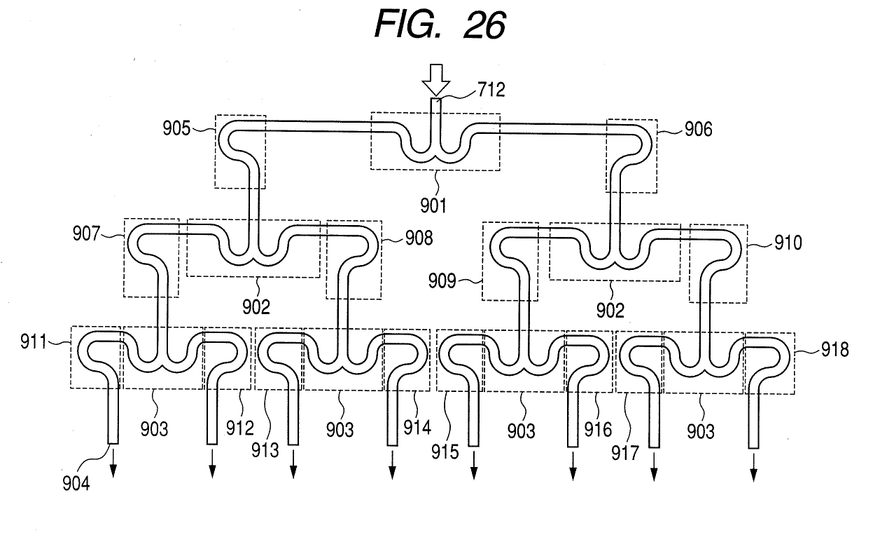

Next, the fluid dividing flow channel 711 (711a or 711b) formed in the fluid dividing flow channel substrate 710 is described in detail. FIG. 26 is an enlarged view of the fluid dividing flow channel 711. As shown in FIG. 26, a flow inlet 712 and a branched portion 901 are connected. The branched portion 901 branches off into two ways, and outlets of the branched portion 901 are connected to inlets of branched portions 902. Outlets of the branched portions 902 are connected to inlets of branched portions 903. Then, outlets of branched portions 903 are connected to flow outlets 904. The fluid having flowed into the flow channel from the flow inlet 710 passes through the branched portions 901 to 903, and flows out of the flow outlets 904.

Movement direction change regions 905 and 906 are present between the branched portion 901 and the branched portions 902. Movement direction change regions 907 to 910 are present between the branched portions 902 and branched portions 903. Movement direction change regions 911 to 918 are present between the branched portions 903 and the flow outlets 904.

The movement direction change regions 905 and 918 function as in the fluid dividing flow channel which changes the direction of movement of the fluid by 90° as described in the column of BEST MODES FOR PRACTICING THE INVENTION. Accordingly, the branched portions 901 to 903 are described here.

The branched portions 901 to 903 are regions where the fluid is divided into two ways, and at the same time, the direction of movement of the fluid is changed by 90°. In the branched portions 901 to 903, two of the fluid dividing flow channel which changes the direction of movement of the fluid by 90° as described in the column of BEST MODES FOR PRACTICING THE INVENTION are provided in combination. Thereby, the fluid is divided into two ways, and at the same time, the direction of movement of the fluid is changed by 90°. The fluid is changed in its movement direction by 90° and thereafter forms the velocity distribution that is symmetrical with respect to the center line of the flow channel.

It is described below how the fluid processing apparatus of this Example operates. A fluid is allowed to flow in from the tube connector 713a by means of a pump, where the fluid flows into the flow channel from the flow inlet 712a, and is divided into eight flows in the fluid dividing flow channel 711a formed in the fluid dividing flow channel substrate 710. Then the fluid thus divided jets out of the nozzles 701a to 708a formed in the nozzle substrate 709. A fluid having flowed in from the flow inlet 712b jets out of the nozzles 701b to 708b entirely in the same way.

Since the nozzles 701a to 708a and the nozzles 701b to 708b are so arranged that their jet-out directions cross one another, both the fluids having jetted out collide with each other to mix or react at the collision part.

In this Example as well, a difference in the flow rate of the fluid divided to each nozzle can be reduced, and hence the uniformity of mixing or reaction can be improved.

### INDUSTRIAL APPLICABILITY

The fluid processing apparatus of the present invention causes fluids to flow out of a plurality of flow outlets at a uniform flow rate, thereby uniformly mixing or reacting the fluids. Hence, it can be utilized in fluid processing systems of chemical industry, biochemical industry, food industry, pharmaceutical industry and so forth.

This application claims the benefit of Japanese Patent Application No. 2007-053255, filed Mar. 2, 2007, which is hereby incorporated by reference herein in its entirety.

1. A fluid transport channel comprising a flow inlet from which fluid flows in, a flow channel through which the fluid is transported, a branched portion which is provided in the flow channel, and changes and branches the direction of movement of the fluid, and a plurality of flow outlets from which the fluid having passed through the branched portions flows out, wherein
a region in which the direction of movement of the fluid is changed is present between the flow inlet and the branched portion;
in the region, a center line extending in the direction of movement of the fluid in the flow channel extends along a range of first and second circular arcs whose centers are located at positions from each other, and the range of first and second circular arcs is composed of a combination of such two circular arcs as to make the directions of the fluid turning along the circular arcs opposite to each other; and
where an angle at which the direction of movement of the fluid changes is defined as θ, the first circular arc has an angle of A×θ and the second circular arc has an angle of (A−1)×θ where A represents a positive integer or decimal.

2. A fluid transport channel in a single series extending from one flow inlet from which fluid flows in, to flow outlets of branched channels which are formed so that a channel is firstly branched at a branched portion where the direction of movement of the fluid is changed and branched, to form two first branched channels, and each of the two first branched channels is secondly branched to form second branched channels, which are further successively branched to form branched channels, wherein
regions where the direction of movement of the fluid is changed are present in the branched channels;
in the regions, a center line extending in the direction of movement of the fluid in each branched channel extends along a range of first and second circular arcs whose centers are located at positions different from each other, and the range of first and second circular arcs is composed of such two circular arcs as to make the directions of the fluid turning along the circular arcs opposite to each other; and
where an angle at which the direction of movement of the fluid changes is defined as θ, the first circular arc has an angle of A×θ and the second circular arc has an angle of (A−1)×θ where A represents a positive integer or decimal.

3. The fluid transport channel according to claim 1 or 2, wherein the A is from 1.8 or more and 2.2 or less.

4. The fluid transport channel according to claim 1 or 2, wherein, where a radius of the first circular arc is defined as R1 and a radius of the second circular arc is defined as R2, a ratio of the R1 to the R2 (R1/R2) is 0.5 or more and 1.5 or less.

5. The fluid transport channel according to claim 1 or 2, wherein the two circular arcs are those combined continuously.

6. The fluid transport channel according to claim 1 or 2, wherein, between the first circular arc and the second circular arc, the flow channel has a straight-line portion having a length of 1/10 or less of the diameter of the flow channel that forms the circular arcs.

7. The fluid transport channel according to claim 1 or 2, wherein the circular arc is composed of a combination of parts of circles, ellipses and/or sides.

8. The fluid transport channel according to claim 1 or 2, which has two regions where the direction of movement of the fluid is changed, between the flow inlet and the branched portion or between the branched portion and the branched portion.

9. A fluid processing apparatus comprising a first-fluid dividing flow channel and a second-fluid dividing flow channel provided correspondingly to the first-fluid dividing flow channel, and causes a first fluid flowing out of the first-fluid dividing flow channel from its flow outlets and a second fluid flowing out of the second-fluid dividing flow channel from its flow outlets to collide with each other to allow the fluids to mix or react, wherein
the first-fluid dividing flow channel and the second-fluid dividing flow channel are each provided with the fluid transport channel according to claim 1 or 2.

10. A fluid processing system comprising the fluid processing apparatus according to claim 9, transport means for transporting the first and second fluids, fluid control means for controlling the transport means, a feed fluid storing apparatus which stores the first and second fluids to be fed to the fluid processing apparatus, a flow-out fluid storing apparatus which stores a treated fluid flowing out of the fluid processing apparatus.
